(19) United States
(12) Patent Application Publication
(10) Pub. No.: US 2003/0220819 A1
(43) Pub. Date: Nov. 27, 2003

(54) Medical management intranet software

(76) Inventors: Bruce Burstein, Palm City, FL (US); Adam Burstein, Brooklyn, NY (US)

Correspondence Address: Richard C. Litman, LITMAN LAW OFFICES, LTD., P.O. Box 15035, Arlington, VA, 22215, US

(21) Appl. No.: 10/151,155

(22) Filed: May 21, 2002

(51) Int. Cl. G06F 17/60

(52) U.S. Cl. 705/3

(57) ABSTRACT

Inranet-based, medical-management software eliminates transcription and greatly simplifies the task of recording symptoms diagnosis, and patient history. At the same time, the software captures data instrumental in productivity analyses and other management functions. The output takes the form of grammatically accurate, readily understood sentences and phrases. The graphical user interface is simple enough that persons who are not sophisticated in computer software can learn how to use it in a short time. Conserving computer storage space and minimizing Internet download time, the software uses a predetermined, minimum number of intelligent templates rather than voluminous boilerplate text.

### BACKGROUND OF THE INVENTION

1. Field of the Invention

The present invention relates generally to computerized medical information-management systems and more specifically to a system that covers all medical conditions with a predetermined, small number of data-entry templates. The present invention compiles data that has been entered and presents it in familiar, grammatical sentences and phrases, therefore, the instant invention eliminates transcription. The instant invention is accessed through a standard, World Wide Web browser, such as Microsoft Internet Explorer or Netscape, and may be accessed through an intranet or the Internet.

2. Description of the Related Art

A discussion of the related art of which the present inventor is aware, and its differences and distinctions from the present invention, is provided below.

Prior art has addressed automation of medical information, but none has been simultaneously comprehensive and easy to use. The instant invention covers all possible medical information while at the same time presenting users with a simple interface. Through the use of a predetermined, limited number of templates, users enter information in on-screen forms that change little from one type of patient visit to another. In prior art, separate templates and separate, on-screen windows must be opened and closed for different medical conditions, diagnoses, interventions and even parts of the anatomy.

In addition, the instant invention employs intelligent data-entry fields that adapt to information entered in previous fields, automatically presenting users with appropriate fields.

U.S. patent application Publication No. US 2002/0035487 A1, published for Tony Brummel, et. al., on Mar. 31, 2002, titled “Intelligent Patient Visit Information Management and Navigation System,” describes a patient health-record system. Brummel's invention leans in the right direction by suggesting choices to the user that are based on data previously entered by the user, but the system squanders the benefit of this feature by relying on numerous templates of boilerplate text. Data entries are inserted into libraries of static text, wasting computer storage space and central-processing-unit cycles, and sacrificing simplicity of user interface. The user interface remains complicated because the user is presented with a multiplicity of different, on-screen forms to complete one medical record.

Further, Brummel makes clear that his software does not dynamically generate conversational language for reports. Instead, information entered by the user is linked to content templates.

U.S. Pat. No. 5,267,155, issued on Nov. 30, 1993, to Ken Buchanan and John A. Dowdle, titled “Apparatus and Method for Computer-Assisted Document Generation,” is a computer-based documentation system, intended to eliminate transcription. But the inventors expressly state that each document template is composed of “boiler plate” text and “holes.” They add that pre-defined character strings are inserted into document template “holes.” Thus, the Buchanan invention is little more than computer-assisted text generation from boiler plate prose. By contrast, the instant invention determines which fields are to be entered and what data is permissible in those fields. In addition, the Burstein invention generates prose dynamically, forming familiar sentences rather than pre-fabricated text plugged with cookie-cutter phrases.

U.S. Pat. No. 5,072,383, issued on Dec. 10, 1991, to John E. Brimm, et. al., titled “Medical Information System with Automatic Updating of Task List in Response to Entering Orders and Charting interventions on Associated Forms,” describes medical-record software that analyzes data and automatically creates a task list from the data. Brimm admirably recognizes the need to replace command-line driven menus with simpler GUI forms, but the end product of the Brimm management system is little more than a computerized “to-do” list with an associated scheduler.

U.S. patent application Publication No. 2002/0022972 A1, published on Feb. 21, 2002, by James B. Costello, titled “Method and System for Creation of an Integrated Medical Record Via a Communications Computer Network,” recognizes the advantages of using the Internet to capture billing data simultaneously with diagnostic and treatment data, but is essentially a single, long template. Because it lacks the flexibility to dynamically adapt to patient data as it is entered, the Costello invention must necessarily present the medical practitioner with numerous, extraneous, data-entry fields that the practitioner must bypass to reach germane data-entry fields.

In addition, the Costello invention is another case in which text is dropped into holes in boilerplate text. The Costello program does not dynamically generate familiar sentences and phrases from entered data.

Further, unlike the instant invention, the Costello computer system is heavily oriented toward billing and financial record keeping and is therefore a more limited medical-information management device than the present invention. The present invention is primarily oriented toward recording medical symptoms and treatment and as an added benefit simultaneously captures billing data.

Also unlike the present invention, the Costello device lacks the ability to record multiple symptoms or interventions along with a principal medical complaint.

In further distinction from the present invention, the Costello program is designed for the small practice, which according to Costello, consists of five or fewer employees. The Burstein invention, in contrast, is fully scalable and is suitable for an office with one doctor or an entire hospital.

U.S. Pat. No. 4,130,881, issued on Dec. 19, 1978, to Herbert A. Haessler, et. al., titled “System and Technique for Automated Medical History Taking,” while automating some functions in recording symptoms and history of patients, is designed for the patients themselves to use, not for the medical practitioner, and is thus much more limited. The Haessler invention also lacks the intelligent templates and data fields of the instant invention and lacks the dynamic prose generation of the present invention.

U.S. Pat. No. 4,893,270, issued on Jan. 9, 1990, to Roger P. Beck, et. al., titled “Medical Information System,” describes a computer system with which a user enters patient visit and medical information, but the system is severely restricted. The Beck medical information system is designed exclusively for hospitals, and is totally unsuited for the practice of smaller clinician. In contrast, the Burstein system can be used in any size practice, from an office with one doctor to a metropolitan hospital.

In addition, unlike the instant invention, the Beck system does not operate on the ubiquitous Internet. Instead, it runs on a private, proprietary network. Further, the outmoded Beck system operates on remote terminals connected to a central database, an architecture that dates from the mainframe-computer days and one that has been almost totally supplanted by networked personal computers and worked stations. The Burstein invention operates on the contemporary model of networked personal computers and work stations.

None of the above inventions and patents, taken either singularly or in combination, is seen to describe the instant invention as claimed. Thus medical management intranet software solving the aforementioned problems is desired.

### SUMMARY OF THE INVENTION

The present invention is a computerized medical information-management system and in particular an easy-to-use system that covers all medical conditions with a small, predetermined number of data-entry templates. The output of the instant invention takes the form of user friendly, grammatically accurate sentences and phrases.

The present invention operates on the Internet and intranets. The graphical user interface of the instant invention is accessed through a standard, World Wide Web browser, such as Microsoft Internet Explorer or Netscape. The graphical user interface is simple enough that persons who are not sophisticated in computer software can learn how to use it in a short time.

By employing only a few templates and intelligent data-entry fields, the present invention greatly simplifies the task of recording symptoms, diagnoses, and patient history. Users do not have to leave one on-screen form and open another to enter separate symptoms, illnesses, and treatments.

By using a minimum, predetermined, number of intelligent templates rather than voluminous boilerplate text, the instant invention conserves computer storage space and CPU cycles and minimizes download time.

Further, the present invention speeds data entry by employing data-entry fields that intelligently adapt to data previously entered by the user, thereby eliminating extraneous fields and screens.

Nor do users of the present invention separately have to enter billing and management data. As medical information is entered, the software simultaneously assigns billing codes and captures data instrumental in productivity analyses and other management functions.

Because the instant invention makes short work of data entry and outputs text in standard, familiar language, it eliminates transcription.

The software is password-protected to authenticate users and to provide privileges based on user log-in. The instant invention relies on secure-sockets-layer encryption through hypertext transport secure protocol. Sensitive data passed between pages relies on Blowfish encryption of specific data.

Accordingly, it is a principal object of the invention to automate medical information management and billing.

It is a further object of the invention to cover all possible medical conditions with a small, predetermined number of universal data-entry templates.

It is another object of the invention is to greatly simplify the task of recording symptoms, diagnoses, orders, patient history, and other medical data through the use of a simple graphical user interface.

It is a further object of the invention to enable data entry by computer mouse clicks, voice commands, touch-sensitive screens, tactile-feedback devices, pointing devices, virtual-reality devices, instrument readings, medical monitoring devices, pre-recorded data, telemetry, and other techniques as may be developed.

Another object of the invention is to definitely indicate that symptoms, conditions, and other medical variables are not present.

Still another object of the invention is to output information in the form of readily understood, grammatically accurate sentences and phrases.

An additional object of the invention is that it output information in paper, electronic, optical, and other forms.

It is another object of the invention that it automatically alert users to risk factors.

It is an additional object of the invention to track the location of patients.

Another object of the invention is to indicate whether a bed is occupied or unoccupied, and whether the bed is ready for occupancy;

A further object of the invention is that it analyze billing and management data.

Another object of the invention is that it output billing statements, insurance reports, management reports, productivity reports, and other administrative documents.

It is a further object of the invention that it operate on the Internet and intranets.

Another object of the instant invention is that it be accessed through a standard, World Wide Web browser, such as Microsoft Internet Explorer or Netscape.

An additional object of the invention is to capture billing and other management data simultaneously with patient medical data, eliminating the need to enter billing and management data separately.

Still another object of the invention is to eliminate transcription.

It is also an object of the invention to conserve computer storage space and central-processing-unit cycles and to minimize download time through the use of a predetermined, minimum number of intelligent templates rather than voluminous boilerplate text.

It is an additional object of the invention to simplify the user interface and speed data entry through the use of intelligent fields that adapt to data previously entered in the on-screen forms, thereby eliminating extraneous fields and screens.

A further object of the invention is that it be password-protected to authenticate users and to provide privileges based on user log-in. The instant invention relies on secure-sockets-layer encryption through hypertext transport secure protocol. Sensitive data passed between pages relies on Blowfish encryption of specific data.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a close-up, partial screen shot of an on-screen, data-entry form.

FIG. 2 is a close-up, partial screen shot of an on-screen, data-entry form.

FIG. 3 is a close-up, partial screen shot of an on-screen, data-entry form.

FIG. 4 is a close-up, partial screen shot of an on-screen, data-entry form.

FIG. 5 is a close-up, partial screen shot of an on-screen, data-entry form.

FIG. 6 is a close-up, partial screen shot of an on-screen, data-entry form.

FIG. 7 is a close-up, partial screen shot of an on-screen, data-entry form.

FIG. 8 is a close-up, partial screen shot of an on-screen, data-entry form.

FIG. 9 is a close-up, partial screen shot of an on-screen, data-entry form.

FIG. 10 is a close-up, partial screen shot of an on-screen, data-entry form.

FIG. 11 is a close-up, partial screen shot of an on-screen, natural-prose report.

FIG. 12 is a close-up, partial screen shot of an on-screen, data-entry form.

FIG. 13 is a close-up, partial screen shot of an on-screen, data-entry form.

FIG. 14A is the first of two logic-flow charts showing the steps in the transformative process in which the software receives entered data and produces natural-language reports.

FIG. 14B is a continuation of the logic-flow chart begun in FIG. 14A.

Similar reference characters denote corresponding features consistently throughout the attached drawings.

### DETAILED DESCRIPTION OF THE PREFERRED EMBODIMENT

The present invention automates medical record keeping and billing, and in particular greatly eases data entry by employing a familiar Internet-style graphical user interface and a few, universal, data-entry templates rather than the massive, boilerplate text employed by prior art.

The present invention operates on an intranet and the Internet, and uses standard Internet coding, protocols, and processes including, but not limited to, hypertext markup language, transmission-control protocol/Internet protocol, secure sockets layer, and dynamic HTML form posting and submit buttons. The instant software is accessed using any standard World Wide Web browser such as Microsoft Internet Explorer, Netscape Navigator, Opera, and the open-source browser Mozilla.

The instant invention is password-protected to authenticate users and to provide privileges based on user log-in. The present invention relies on secure-sockets-layer encryption through hypertext transport secure protocol. Sensitive data passed between pages relies on Blowfish encryption of specific data.

The present invention employs an easy-to-use graphical user interface that presents the user with a familiar interface of on-screen forms and fields, consisting of selection check boxes, option buttons, combo boxes, drop-down lists, tabs, memo fields, scroll bars, menus, and other Windows-type features.

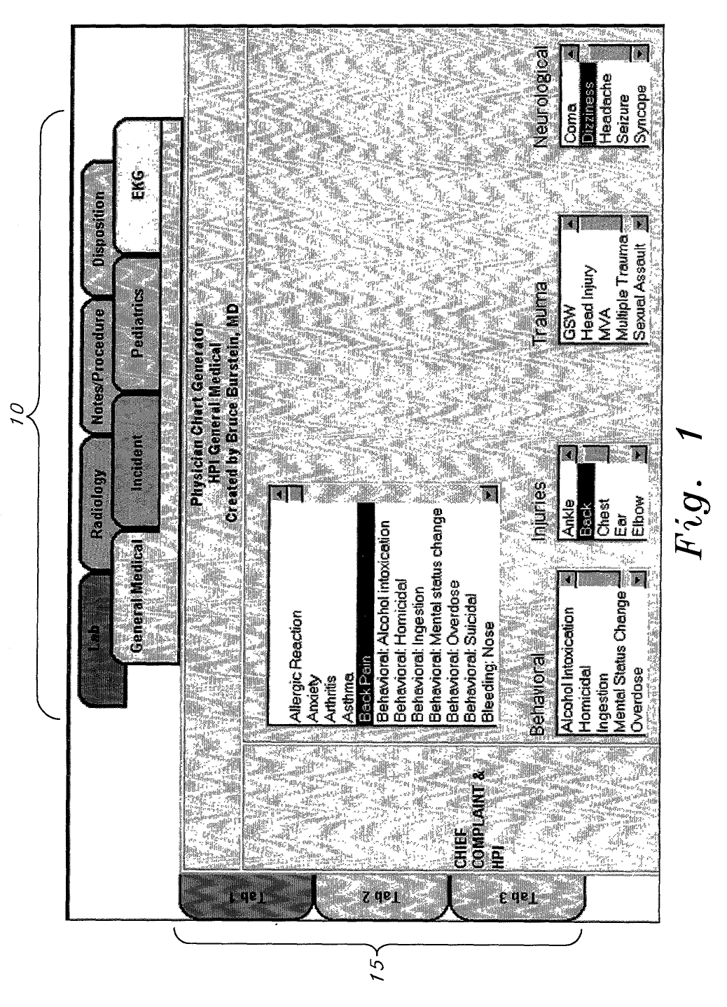

FIG. 1 is a close-up, partial screen shot of the initial page of the present invention. Tabs at the top 10 and tabs on the left side 15 represent different on-screen forms. When the user clicks on a tab with the computer mouse, the screen changes to the appropriate form. Once a health-care professional selects a patient, the software displays the three tabs on the left 15. Labeled Tab 1, Tab 2, and Tab 3 in the figure, the three tabs represent the major job functions of medical personnel. They are 1) documentation, 2) medical-order entry, and 3) view data (patient information). Within each of these sections, the tabs at the top 10 allow sub-forms of appropriate fields. Sub-forms in which to enter major classes of medical treatment such as pediatrics and nursing are thus clearly separated but readily reached. Sample sub-forms and fields are shown in the following table.

| Documentation Tab | Order Entry Tab | View Data Tab |
|---|---|---|
| History | Laboratory | Recent Summary (all |
| | | below) |
| Physical | Radiology | Laboratory |
| EKG | Cardiology | Radiology |
| Radiographs | Nursing | Special Studies |
| Laboratory | Pulmonary | Reports and Documents |
| Notes | Equipment | Demographics (includes all |
| | | regular documentation) |
| Procedure | Special Studies | |
| Disposition | Consultations | |
| Nursing | | |
| Triage | Laboratory | Recent Summary (all |
| | | below) |
| Assessment | Radiology | Laboratory |
| Notes | Cardiology | Radiology |
| Interventions | Nursing | Special Studies |
| Discharge Instructions | Pulmonary | Reports and Documents |
| | Equipment | Demographics (includes all |
| | | regular documentation) |
| | Special Studies | |
| | Consultations | |
| Registration | | |
| Demographics | (disabled) | Demographics (includes all |
| | | regular documentation) |
| Advanced Directives | | |
| Insurance Information | | |
| Next of Kin | | |
| Contact Information | | |
| Employer Information | | |
| Guarantor | | |
| Primary Care Physicians | | |
| Respiratory Technicians | | |
| Respiratory Assessment | Pulmonary | Recent Summary (all |
| | | below) |
| Ventilator Settings | | Laboratory |
| Interventions | | Radiology |
| | | Special Studies |
| | | Reports and Documents |

The software therefore permits the user to reach a desired on-screen, data-entry, form without clicking or paging through irrelevant, intervening screens. The user may further customize the sequence of screens to increase the efficiency of that particular user's usual order of entering data.

The user can set the default section that will open after the user selects a patient. For example, Dr. X can set the Order Entry section to open after selecting patient Z. Dr. Y can set the Documentation section to open after selecting patient Z. All forms and all fields are available to both physicians. They are simply able to customize the interface so that it is more efficient for them.

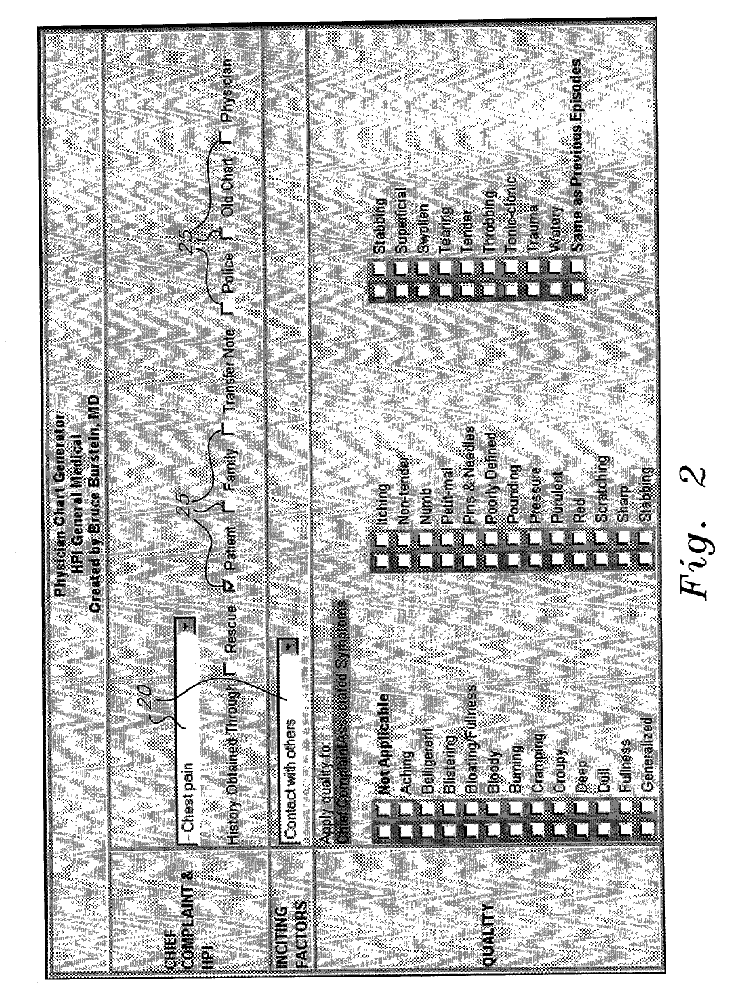

FIG. 2 is a close-up, partial screen shot of the main form, showing four sections of the physician chart generator. Users enter data by making selections from drop-down boxes 20 and by clicking with the mouse in small squares 25. Users may also enter data by voice commands, touch-sensitive screens, tactile-feedback devices, pointing devices, virtual-reality devices, instrument readings, medical monitoring devices, pre-recorded data, telemetry, and other techniques as may be developed.

Information available to the user is privilege- and permission-based. Therefore, a health-care practitioner will not be able to review other patients' notes unless proper authority is granted.

As a medical practitioner fills in the on-screen form with symptom and treatment information, the software consults internal business rules plus stored procedures and data held in relational databases to present appropriate additional choices.

Through the use of data-assembly rules that react to user input, the number of templates confronting a user is reduced to a few, broadly applicable templates that can accommodate any medical condition and any patient encounter. By contrast, other popular medical-management systems rely on a separate template for each medical condition. Physicians, regardless of specialty, will be able to use universal history and physical templates in the present invention. If the user wishes modifications, for example, if an ear, nose, and throat specialist wants more specialized nasal examination points, these can be accommodated by adjusting the database that drives the template.

The software eliminates storage of massive text templates by relying on intelligent data fields and intelligent data assembly. Data entered in one field influences choices available in succeeding fields, narrowing the choices and reducing the chance of mistakes.

Employing contemporary Web browser techniques, the software causes pop-up windows to appear when a practitioner selects certain medical conditions an interventions. Said pop-up windows immediately furnish the practitioner with pertinent, additional information. The pop-up windows appear only when needed, conserving precious screen space. The pop-up windows are closed by the conventional Windows technique of clicking with the mouse on a small box with an “X” in it at the upper right-hand corner of the pop-up window.

Nursing has a very different function from that of the physician, and hence different documentation. Examples of nursing interventions are starting an intravenous-fluid drip and applying oxygen. The nursing-intervention template is unique, and far superior to prior art. Other computer systems require nurses to document each intervention on separate on-screen forms, which necessitates opening and closing multiple forms to record what is essentially related data. With the instant invention, nurses can record multiple interventions on one form.

In like manner, the memo fields in which physician record notes also will allow the documentation of multiple interventions, for example, IV fluids given and laceration repair performed.

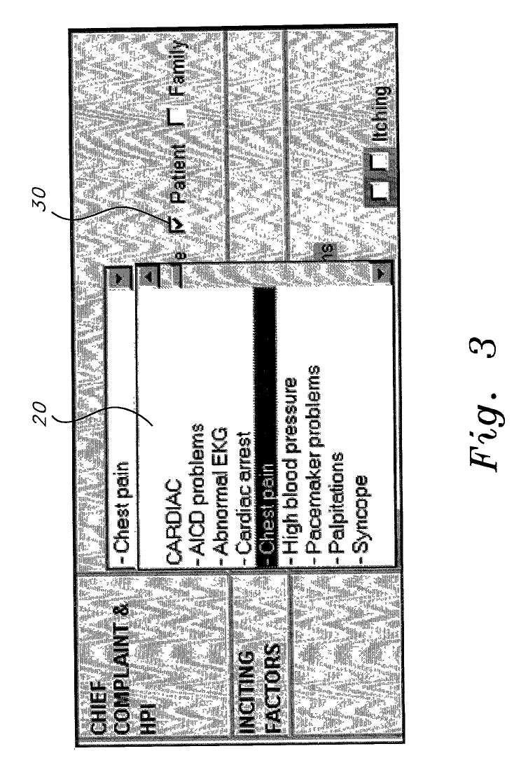

FIGS. 3 through 10 illustrate the variety of information that can be noted by the physician on a single form. In stark contrast to prior art, there is utterly no need to close one form and open another to record data that medically and logically belong together.

FIG. 3 is a close-up, partial screen shot of the chief-complaint section shown in FIG. 2. In FIG. 3, a user has selected “Chest pain” from a list of symptoms in a drop-down box 20. The user has also placed a check mark in the “Patient” field 30 to indicate that the patient's medical history was obtained from the patient.

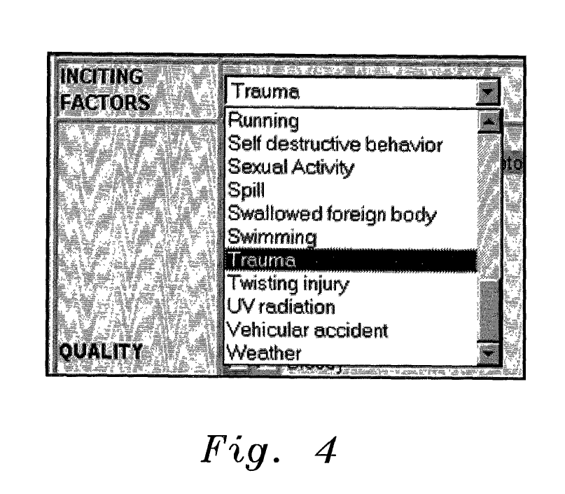

FIG. 4 is a close-up, partial screen shot of the inciting-factors section shown in FIG. 2.

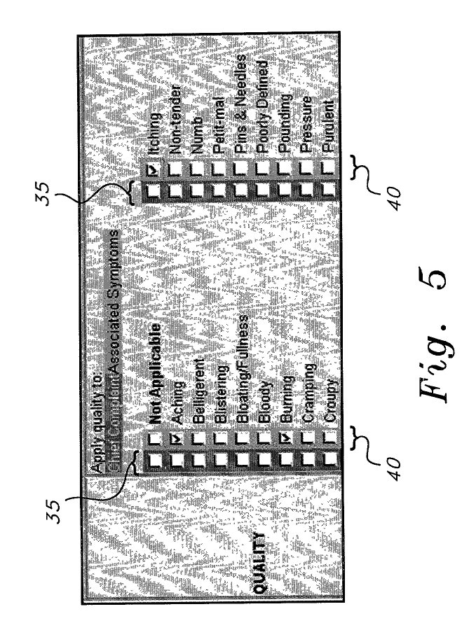

FIG. 5 is a close-up, partial screen shot of the quality section shown in FIG. 2. In this section, the medical practitioner expands on and qualifies the chief complaint. Check boxes framed in dark gray 35 indicate characteristics of the chief complaint. Check boxes framed in light gray 40 indicate associated symptoms. FIG. 5 clearly shows that two separate functions can be carried out without switching from screen to screen, which is a key feature of the instant invention.

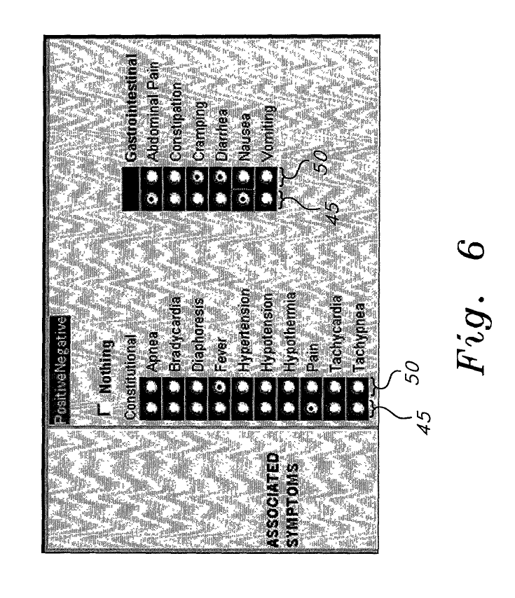

FIG. 6 is a close-up, partial screen shot of the associated-symptoms section shown in FIG. 2. In FIG. 6, another key feature of the present invention can be seen, which is the ability to definitely record that various symptoms and findings are not present by simply making a yes or no selection. By clicking in one set of option buttons 45, the practitioner indicates that symptoms are present. By clicking in another set of option buttons 50, the practitioner indicates that symptoms are not present. The absence of a symptom can be as important as the presence of symptoms in diagnosing an illness.

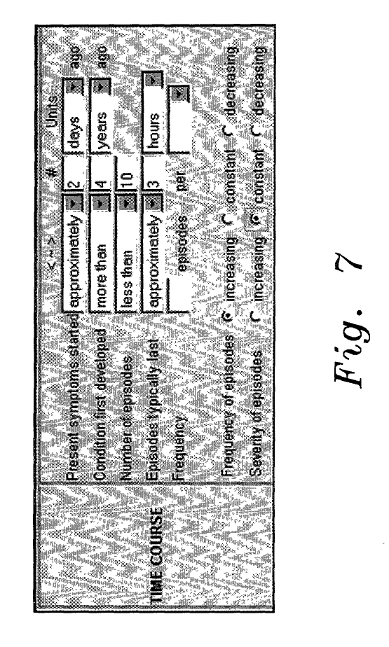

FIG. 7 is a close-up, partial screen shot of the time-course section, another section of the physician chart generator, part of which is shown in FIG. 2. In the time-course section, the physician notes the onset, duration, frequency, and severity of episodes of a complaint.

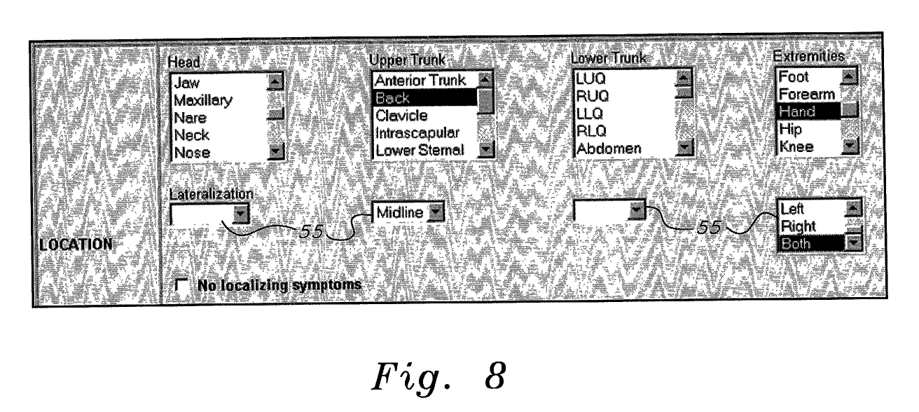

FIG. 8 is a close-up, partial screen shot of the location section, another section of the physician chart generator, part of which is shown in FIG. 2. In the location section, the physician notes the location of the injury or illness. It can be seen clearly that multiple parts of the body can be noted, in contrast to prior art, in which separate forms must be filled out for hands, feet, and other anatomy. In addition, qualifying fields 55 add to the information that can be noted. FIG. 8 demonstrates that the instant invention overcomes a deficiency inherent in other, widely used medical-management software, which is the inability to note more than one medical condition at a time. Other software requires users to open separate on-screen forms and to alternate back-and-forth between on-screen windows in order to record the details of separate medical complaints. With the present software, a plurality of medical problems can be recorded at one time, on one on-screen form, without switching among computer windows. An example of a common illness that produces two different complaints is fainting. Fainting frequently produces a fall. The fall often results in a head injury. With the inventors' software, both conditions can be recorded on one screen, whereas with other software, the conditions must be recorded on separate screens in separate windows.

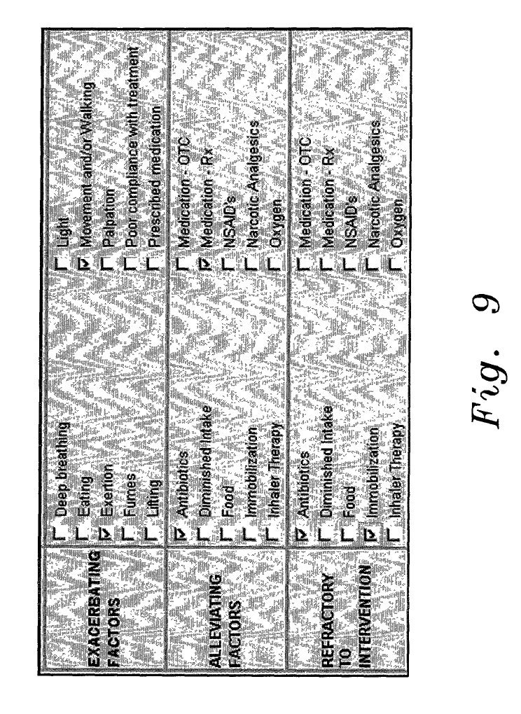

FIG. 9 is a close-up, partial screen shot of three more sections of the physician chart generator, part of which is shown in FIG. 2. Again, without changing forms or windows, a health-care professional can quickly enter a multiplicity of information about a patient. In this case, by merely clicking the mouse, the user can record exacerbating factors, alleviating factors, and treatment.

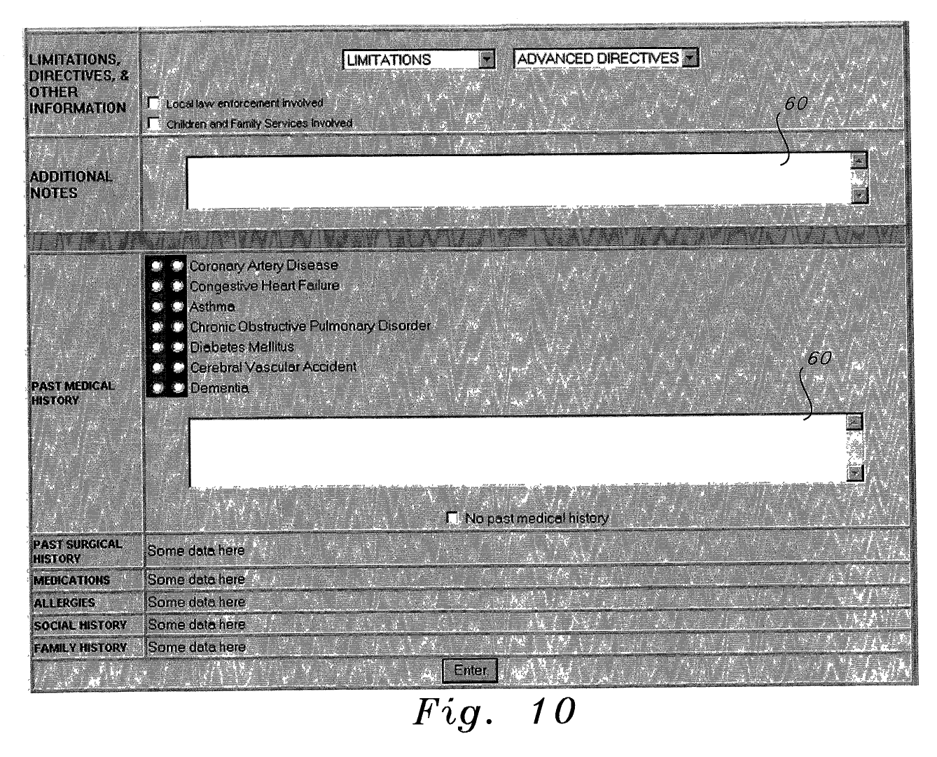

FIG. 10 is a close-up, partial screen shot showing additional sections of the physician chart generator, part of which is shown in FIG. 2. Two memo fields 60 are shown, where the user can add information not obtainable through mouse clicks.

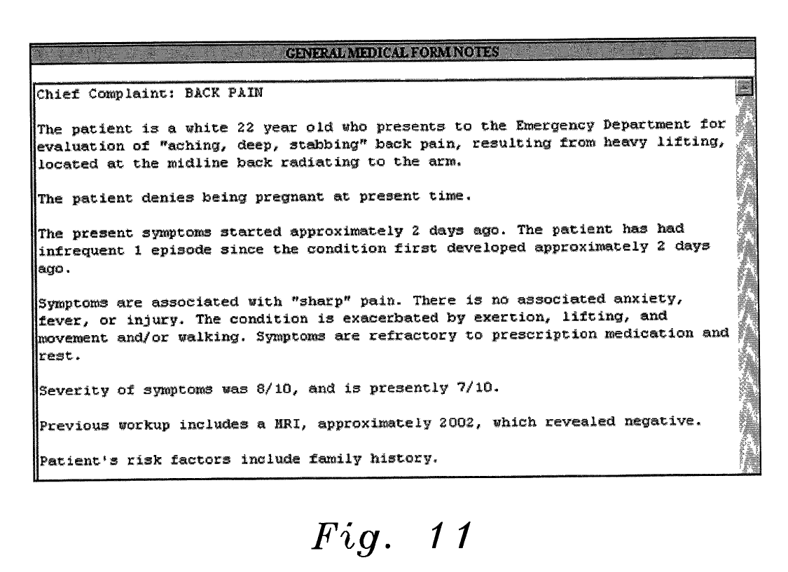

FIG. 11 is a close-up, partial screen shot of a report prepared from the data entered in the physician chart. The results are presented in plain, natural language that follows the rules of widely accepted grammatical standards. The same internal business rules and stored procedures and data in databases that are consulted in order to intelligently present relevant fields and information when the user fills out an on-screen form come into play when the software generates a report. In addition, the program calls into play logical tests and language rules in order to form natural prose.

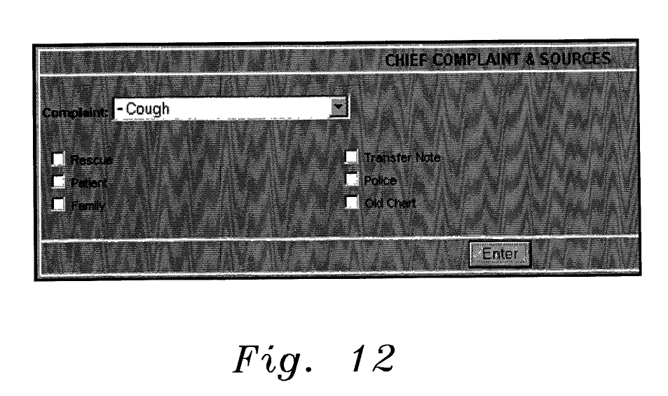

FIG. 12 is a close-up, partial screen shot of the chief complaint and sources form. When the physician clicks on the Enter button with the mouse, the software checks the nature of the complaint and alerts the physician to high-risk symptoms that also should be checked.

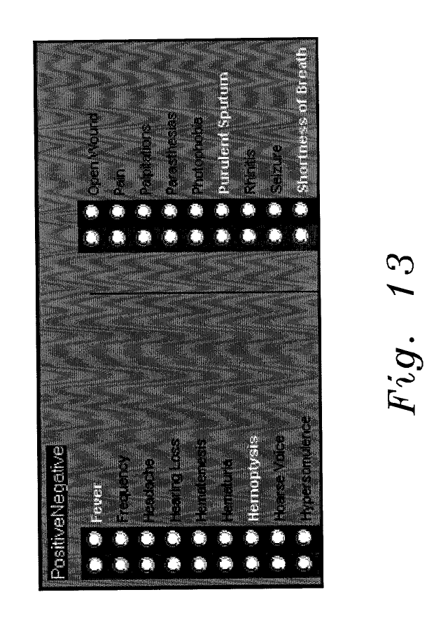

FIG. 13 is a close-up, partial screen shot of the high-risk alerts prompted by the form shown in FIG. 12. High-risk symptoms are shown in white lettering.

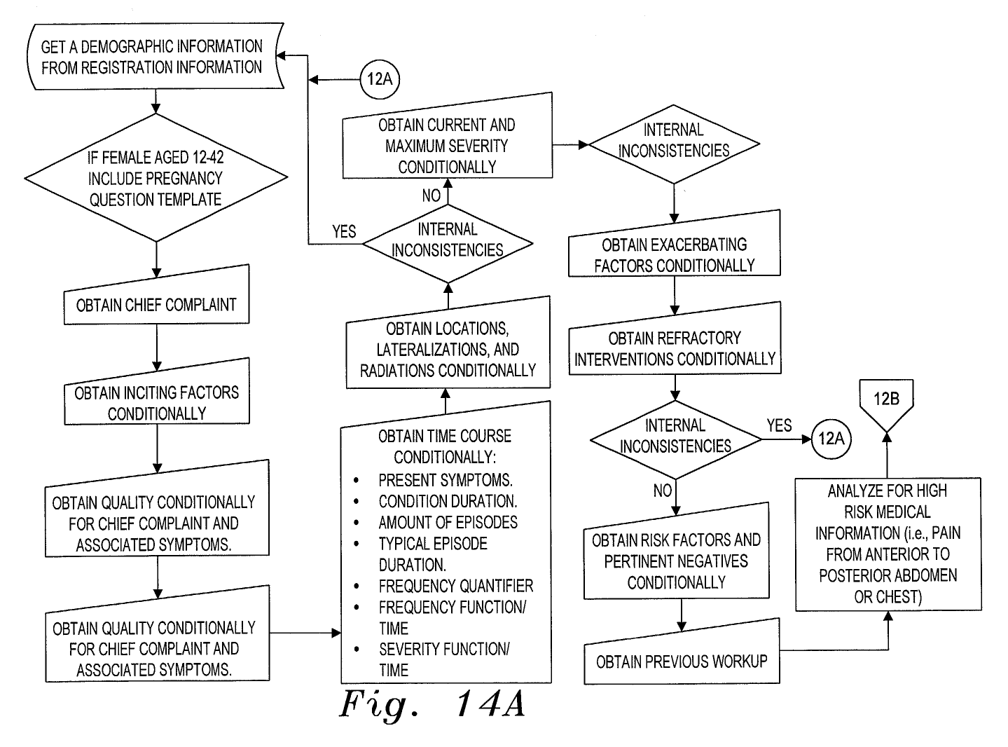

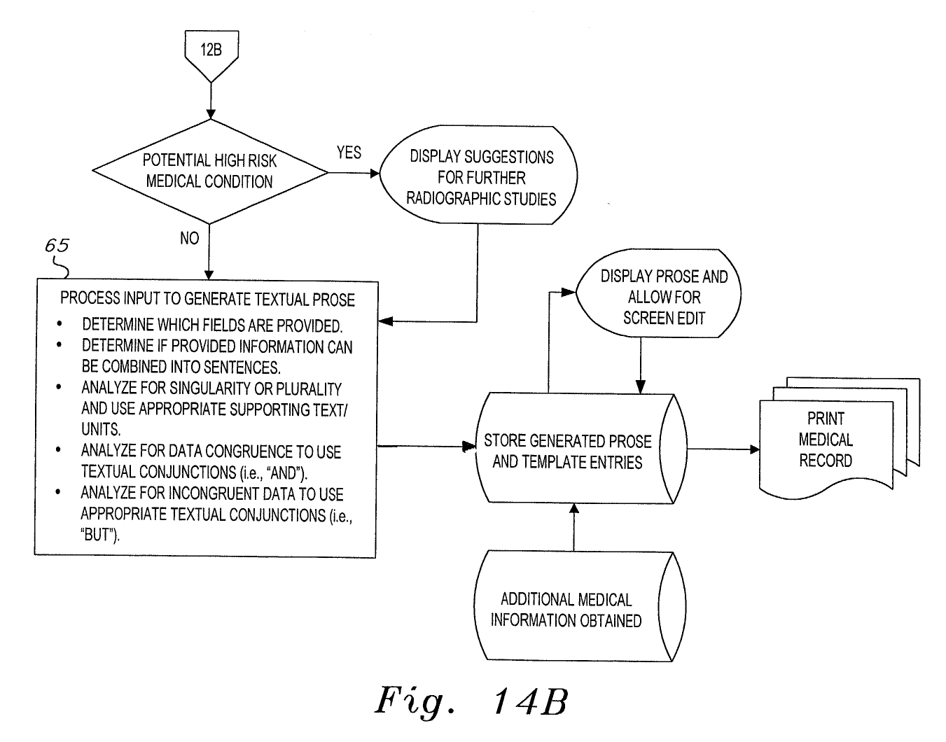

FIG. 14A is the first of two flow charts showing the transformative steps in which a medical practitioner enters patient information and the present invention processes that information.

FIG. 14B is a continuation of the flow chart begun in FIG. 14A. The output of the present invention is natural language in grammatically correct sentences and phrases. The process by which the software composes reports in grammatically correct sentences and phrases consists of the following steps, depicted at point 65:

1) Determine which fields have been populated with data.

2) Determine if information collected in step 1 can be combined into sentences.

3) Determine if singular or plural and use appropriate supporting text and units.

4) Analyze data congruence to determine conjunctions such as “and” and “or”.

5) Check for incongruent data to use appropriate conjunctions such as “but”.

The present invention has as an integral part a patient-tracking system by which anyone with suitable access permissions on an intranet may locate a patient. Said method expedites inquiries by family members and others about the status of a patient and facilitates the work of radiology technicians, nurses, and other health-care professionals who must locate patients to deliver care and acquire information.

The instant invention automates billing. As practitioners enter data acquired in the course of treatment, the information automatically is coded for billing, including procedures, interventions, and historical and physical examination documentation. The automation eliminates an entire step in the billing process. Traditionally a typed or handwritten medical record must be manually reviewed by a “coder” who reviews the documents for items that can be billed and then types the items into a billing system. The present invention eliminates manual entry of billing information.

The present invention is designed to record patient data and manage medical environments of all sizes, from the single practitioner to a large hospital. The present software is available in different versions to fit medical practices of different sizes. For example, the Management Suite version is designed for large medical facilities and hospitals and includes data-entry templates for nursing, respiratory therapy, case management, housekeeping, and engineering. The Management Suite version also provides management reports, for example, occupied bed-hours, unoccupied bed-hours, and length-of-stay reports. The Management Standard version, designed for the small practice, has fewer modules and is designed for physician documentation and basic registration.

The instant invention includes flags in the form of pop-up screens and other reminders when symptoms indicate caution, tests, or treatment. For example, when a physician records abdominal pain radiating to the back, the program recommends evaluation for abdominal, aortic aneurism. If chest pain is noted as radiating to the back, the software recommends evaluation for aortic dissection. Patients identified as smokers automatically receive smoking-cessation information at time of discharge.

The present invention operates in client/server fashion. Personal computers, handheld computers, and workstations serve as the clients. In small medical practices, clients will access remote Web-page servers hosted by service providers in typical Internet manner, through TCP/IP protocol. Large medical practices, such as hospitals, may choose to provide both clients and servers.

Updates to the instant software, including new diagnoses, treatments, and medicines are made to the database on the server and are transparent to the end user.

It is to be understood that the present invention is not limited to the sole embodiment described above, but encompasses any and all embodiments within the scope of the following claims.

We claim:

1. A computerized system for medical management on an intranet, comprising:
a) at least one server computer having a processor, an area of main memory for executing program code under the direction of the processor, a storage device for storing data and program code and a bus connecting the processor and the storage device;
b) at least one relational database stored on said storage device;
c) a data communications device connected to said bus for connecting said server computer to the Internet;
d) at least one client computer having a processor, an area of main memory for executing program code under the direction of the processor, a storage device for storing data and program code and a bus connecting the processor and the storage device;
e) a data communications device connected to said bus for connecting said client computer to the Internet;
f) means of entering data, including, but not limited to, computer mouse and keyboard;
g) data output in paper, electronic, optical, and other forms;
h) computer program code stored in the server storage device and executing in the server main memory under the direction of the server processor, the computer program including:
1) a predetermined, small number of universal templates that display, in a graphical user interface, medical conditions;
2) means for creating, from data entered by the user, reports in natural language consisting of grammatical, readily understood sentences and phrases;
3) intelligent data fields that adapt according to data previously entered by the user.
4) a graphical user interface of on-screen forms;
5) a graphical user interface by which users indicate that symptoms and other medical conditions definitely are not present;
6) a graphical user interface that alerts practitioners to high-risk factors;
7) means of tracking the location of patients;
8) means of indicating whether a bed is occupied or unoccupied and whether the bed is ready for occupancy;
9) means of capturing billing and management data simultaneously with the user's entry of medical
10) means of analyzing billing and management data and subsequently outputting billing statements, insurance reports, management reports, productivity reports, and additional administrative documents.

2. The computerized system according to claim 1, and including:
a) means for functioning on the Internet;
b) software that is independent of the computer platform; and
c) software that is scalable from the smallest medical organization to the largest medical organization.

3. A computer program product that includes a medium readable by a processor, the medium having stored thereon a set of instructions for medical management on an intranet, comprising:
a) a first sequence of instructions which, when executed by the processor, causes the processor to produce a predetermined, small number of universal templates that display, in a graphical user interface, all possible medical conditions;
b) a second sequence of instructions which, when executed by the processor, causes the processor to create, from data entered by the user, reports in natural language consisting of grammatical, readily understood sentences and phrases;
c) a third sequence of instructions which, when executed by the processor, causes the processor to display intelligent data fields that adapt according to data previously entered by the user;
d) a fourth sequence of instructions which, when executed by the processor, causes the processor to display a graphical user interface of on-screen forms;
e) a fifth sequence of instructions which, when executed by the processor, causes the processor to display a graphical user interface by which users indicate that symptoms and other medical conditions definitely are not present;
f) a sixth sequence of instructions which, when executed by the processor, causes the processor to display a graphical user interface that alerts practitioners to high-risk factors;
g) a seventh sequence of instructions which, when executed by the processor, causes the processor to track the location of patients;
h) an eighth sequence of instructions which, when executed by the processor, causes the processor to indicate whether a bed is occupied or unoccupied and whether the bed is ready for occupancy;
i) a ninth sequence of instructions which, when executed by the processor, causes the processor to capture billing and management data simultaneously with the user's entry of medical data; and
j) a tenth sequence of instructions which, when executed by the processor, causes the processor to analyze billing and management data and subsequently output billing statements, insurance reports, management reports, productivity reports, and additional administrative documents.
